(19) United States
(12) Patent Application Publication
(10) Pub. No.: US 2022/0375703 A1
(43) Pub. Date: Nov. 24, 2022

(54) SWITCH DEVICE

(71) Applicant: KABUSHIKI KAISHA TOKAI RIKA DENKI SEISAKUSHO, Aichi (JP)

(72) Inventor: Yosuke HATADA, Aichi (JP)

(21) Appl. No.: 17/742,910

(22) Filed: May 12, 2022

(30) Foreign Application Priority Data
May 18, 2021 (JP) 2021-084194

(51) Int. Cl. H01H 21/22; H01H 21/12

(52) U.S. Cl. CPC H01H 21/22; H01H 21/12; B60T 7/085

(57) ABSTRACT

A switch device includes a knob, a support to support the knob to be movable in a linear direction, a switch main body to make electrical switching upon an operation of the knob, and a detent member to give a detent feeling to the operation on the knob. The knob, the switch main body and the detent member are serially arranged in the linear direction.

### CROSS-REFERENCE TO RELATED APPLICATIONS

The present patent application claims the priority of Japanese patent application No. 2021/084194 filed on May 18, 2021, and the entire contents of Japanese patent application No. 2021/084194 are hereby incorporated by reference.

### TECHNICAL FIELD

The present invention relates to an electrical switch device.

### BACKGROUND ART

A parking brake switch device is known which is disposed at a tip portion of a lever main body of a shift lever operated by a driver (e.g., Patent Literature 1).

### CITATION LIST

### Patent Literature

Patent Literature 1: JP 2020/111297 A

### SUMMARY OF INVENTION

The switch device disclosed in Patent Literature 1 may cause a problem that it is difficult to provide with an appropriate operating force to allow an operator to obtain an appropriate detent feeling as it is somewhat downsized.

It is an object of the invention to provide a switch device which can have an appropriate operating force to allow an operator to obtain an appropriate detent feeling even when downsized.

According to an aspect of the invention, a switch device comprises:
a knob;
a support to support the knob to be movable in a linear direction;
a switch main body to make electrical switching upon an operation of the knob; and
a detent member to give a detent feeling to the operation on the knob,
wherein the knob, the switch main body and the detent member are serially arranged in the linear direction.

### ADVANTAGEOUS EFFECTS OF INVENTION

According to an embodiment of the invention, a switch device can be provided which can have an appropriate operating force to allow an operator to obtain an appropriate detent feeling even when downsized.

### BRIEF DESCRIPTION OF DRAWINGS

FIG. 1 is a diagram illustrating a portion in front of a driver's seat of a vehicle on which a switch device in the first embodiment of the present invention is mounted.

FIG. 2 is a schematic structural cross-sectional view showing the switch device in the first embodiment of the invention.

FIG. 3 is an explanatory circuit diagram illustrating the switch device in the first embodiment of the invention.

FIG. 4 is a diagram illustrating stroke characteristics of the switch device in the first embodiment of the invention.

FIGS. 5A to 5C are explanatory schematic structural cross-sectional views showing an operation of the switch device in the first embodiment of the invention.

FIG. 6 is a schematic structural cross-sectional view showing the switch device in the second embodiment of the invention.

FIG. 7 is a diagram illustrating stroke characteristics of the switch device in the second embodiment of the invention.

### DESCRIPTION OF EMBODIMENTS

### First Embodiment

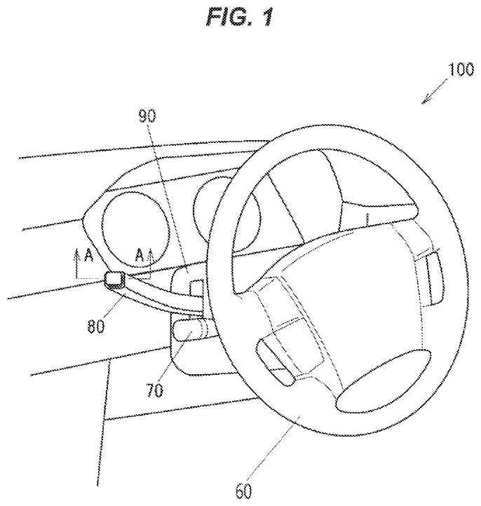

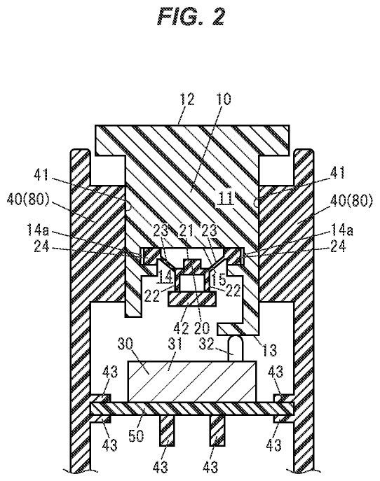

FIG. 1 is a diagram illustrating a portion in front of a driver's seat of a vehicle on which a switch device in the first embodiment of the invention is mounted. FIG. 2 is a schematic structural cross-sectional view showing the switch device in the first embodiment of the invention and is a cross-sectional view taken along line A-A in FIG. 1.

A switch device 1 can act as a switch device to accept operations on a device to be controlled and can be applied to various types of devices. In the first embodiment, it will be described as being mounted on a shift lever 80 of a vehicle 100, and the device to be controlled will be described as, e.g., an EPB (Electric Parking Brake).

The switch device 1 in the first embodiment of the invention is mounted near a tip portion of the rod-shaped shift lever 80 that extends from a steering column 90 (to which a steering wheel 60 is attached) of the vehicle 100 shown in FIG. 1.

As shown in FIG. 2, the switch device 1 is composed of a knob 10, a rubber dome 20 as a detent member, a main body 30 of a switch, a support 40 (the shift lever 80), and a circuit board 50.

The knob 10 is formed of a resin and has a pillar portion 11, an operation portion 12, a pushing portion 13 to push the main body 30, a housing portion 14, and a pushing portion 15 to push the rubber dome 20. The knob 10 is supported by a supporting portion 41 of the support 40 (the shift lever 80) so as to be movable in a linear direction which is a vertical direction in FIG. 2.

The pillar portion 11 is in a columnar shape having an axis in a direction along the shift lever 80 which serves as the support 40. The operation portion 12 is formed at one end (an upper end in FIG. 2) of the pillar portion 11 and has a flange shape slightly larger than the pillar portion 11. The operation portion 12 is arranged at the tip portion of the shift lever 80. The operation portion 12 is a portion that an operator pushes when operating the switch device 1.

The pushing portion 13 is formed at a position extended from the other end (a lower end in FIG. 2) of the pillar portion 11 in the direction along the shift lever 80. The pushing portion 13 is a portion with which the knob 10 pushes the main body 30 when the operator pushes the operation portion 12.

The housing portion 14 is a recess formed at the other end (the bottom end in FIG. 2) of the pillar portion 11. The housing portion 14 houses the rubber dome 20. An installation portion 14a is a portion to which the rubber dome 20 is attached.

The pushing portion 15 is a bottom surface of the housing portion 14 (in FIG. 2, an upper surface of the housing portion 14). The pushing portion 15 is a portion with which the knob 10 pushes the rubber dome 20 when the operator pushes the operation portion 12.

The rubber dome 20 is formed of a rubber and has a substantially rotationally symmetric shape. The rubber dome 20 has a base portion 21 having a columnar shape, a cylindrical portion 22 having a circular cylindrical shape, a thin skirt portion 23, and a fixed portion 24. The cylindrical portion 22, which is one end of the axis of symmetry, has a small diameter, and the fixed portion 24, which is the other end, has a large diameter.

On the fixed portion 24 side where the rubber dome 20 has a large diameter, the rubber dome 20 is attached to the installation portion 14a of the knob 10 and is housed in the housing portion 14 of the knob 10. On the cylindrical portion 22 side where the rubber dome 20 has a small diameter, the rubber dome 20 is mounted on a supporting portion 42 of the support 40.

That is, the rubber dome 20 is arranged so as to be sandwiched between the knob 10 and the supporting portion 42 of the support 40. Thus, when the knob 10 is operated, the rubber dome 20 moves together with the knob 10, while the supporting portion 42 serves as a wall that restricts movement of the rubber dome 20. Then, the skirt portion 23 and the cylindrical portion 22, etc., which are deformable portions of the rubber dome 20, are elastically deformed.

The rubber dome 20, and also the installation portion 14a and the supporting portion 42 for the rubber dome 20, are arranged within a width of the knob 10 (in a left-right direction of FIG. 2). Thus, the support 40 (the shift lever 80) can be formed thin without being subjected to restriction caused by attaching the rubber dome 20. In addition, the cylindrical portion 22 side where the rubber dome 20 has a small diameter is at the far side of the rubber dome 20 with respect to the knob 10, hence, the supporting portion 42 serving as a wall to restrict movement of the rubber dome 20 can be designed to be small. It is thus possible to increase the degree of freedom in designing the knob 10 around the pushing portion 13 that pushes the main body 30.

The main body 30 is composed of a case 31 and an operation portion 32. The main body 30 has two microswitches in the case 31. The microswitch has electrical contacts and a small rubber (not shown). The operation portion 32 is supported by the case 31 so as to be movable in the vertical direction of FIG. 2.

The operation portion 32 receives an upward biasing force of a spring. When a force from above is not applied, the operation portion 32 is in a largely protruding state, as shown in FIG. 2. When the operation portion 32 is pushed by the pushing portion 13 of the knob 10 and receives the force applied from above, the operation portion 32 becomes less protruding and pushes the small rubbers (not shown). The rubbers (not shown) are then deformed, which changes connection state of the electrical contacts and the state of the two microswitches.

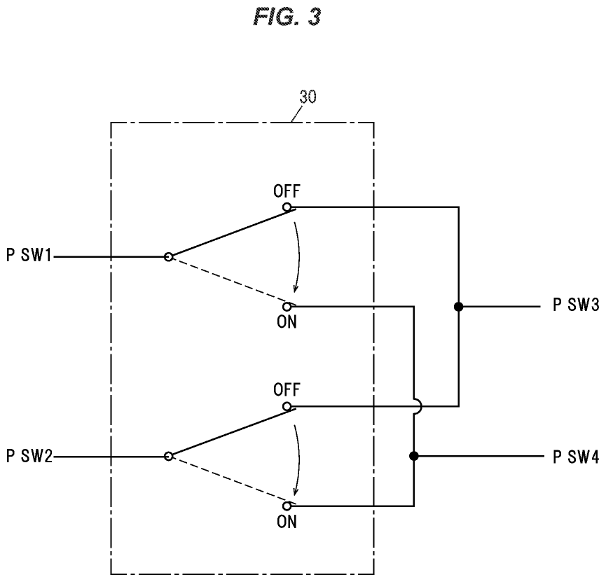

Each of the two microswitches of the main body 30 has two contacts, as shown in FIG. 3. The two contacts are in the OFF state when not pushed by the operation portion 32 and are in the ON state when pushed.

The main body 30 is mounted on the circuit board 50. The main body 30 has a circuit configuration which can be a normally-closed circuit where a closed circuit is always present, as shown in FIG. 3.

That is, two electrical terminals: P SW1, P SW2 of the main body 30 are connected to the two microswitches. Respective OFF-side terminals of the two microswitches are connected to an electrical terminal: P SW3 of the main body 30. Respective ON-side terminals of the two microswitches are connected to an electrical terminal: P SW4 of the main body 30. Thus, when the two microswitches are OFF, the electrical terminals: P SW1, P SW2 have a path to the electrical terminal: P SW3. When the two microswitches are ON, the electrical terminals: P SW1, P SW2 have a path to the electrical terminal: P SW4.

Due to this circuit configuration of the main body 30, the switch device 1 operates as a normally-closed circuit where a closed circuit is always present, and it is a device that has a fail-safe function excellent in detecting abnormalities such as wire breakage.

The circuit board 50 may be a plate-shaped substrate or a flexible substrate. Alternatively, it may be configured to omit the substrate and to use cable output directly from the main body.

### Operation of the Switch Device 1

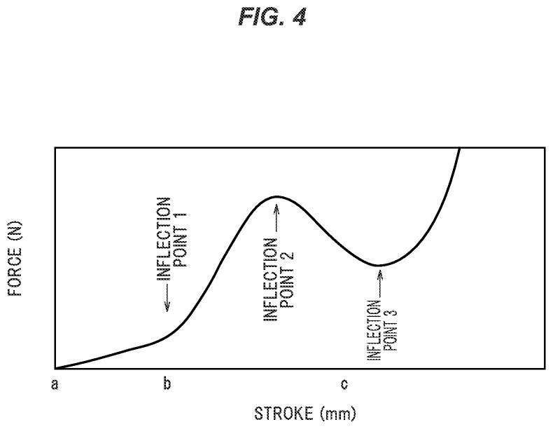

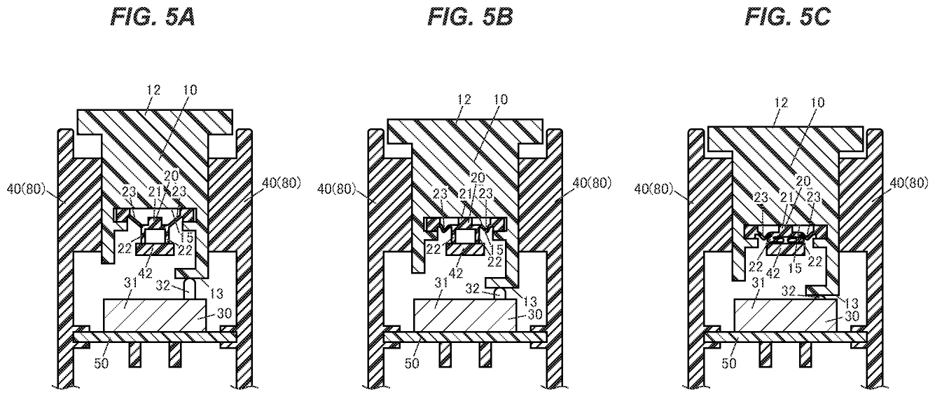

FIG. 4 is a diagram illustrating stroke characteristics of the switch device in the first embodiment of the invention. FIGS. 5A to 5C are explanatory schematic structural cross-sectional views showing an operation of the switch device in the first embodiment of the invention. FIG. 5A is a diagram before performing an operation, FIG. 5B is a diagram near an inflection point 1, and FIG. 5C is a diagram near an inflection point 3.

FIG. 4 is a stroke characteristic diagram in which the horizontal axis indicates stroke (mm) of the knob 10 and the vertical axis indicates force (N) generated on the knob 10. The reference position for the stroke (mm) of the knob 10 is a position before the operator operates the switch device 1, and the force (N) at that time in 0 (N). The operator feels a force generated on the knob 10 according to a stroke of pushing the operation portion 12 of the knob 10. FIGS. 5A, 5B and 5C are schematic structural cross-sectional views of the switch device respectively at stroke positions a, b, and c FIG. 4.

FIG. 5A is a diagram illustrating the state before the operator operates the switch device 1. The rubber dome 20 is not receiving an external force and is not deformed. The operation portion 32 of the main body 30 is in a largely protruding state. Each of the two microswitches of the main body 30 is in the OFF state.

When the operator pushes the operation portion 12 of the knob 10 from the state shown in FIG. 5A, firstly, mainly the skirt portion 23 of the rubber dome 20 is elastically deformed. The operation portion 32 of the main body 30 is pushed by the pushing portion 13 of the knob 10 and its protruding length decreases gradually. Each of the two microswitches of the main body 30 is still in the OFF state.

FIG. 5B is a diagram illustrating the state near the inflection point 1 in FIG. 4. At this time, the knob 10 is lowered and the pushing portion 15 of the knob 10 is in contact with the base portion 21 of the rubber dome 20.

When the operator further pushes the operation portion 12 of the knob 10 from the state shown in FIG. 5B, secondly, the cylindrical portion 22 of the rubber dome 20 is also elastically deformed. The operation portion 32 of the main body 30 is pushed by the pushing portion 13 of the knob 10 and its protruding length further decreases. Each of the two microswitches of the main body 30 is still in the OFF state.

As shown in FIG. 4, the force felt by the operator when the operator pushes the operation portion 12 of the knob 10 is small from the stroke position a to the position b and increases after the position b since deformation of the cylindrical portion 22 is added. The force required for deformation is larger for the cylindrical portion 22 which is thicker than the skirt portion 23 and has an axis in the moving direction of the knob 10, than for the skirt portion 23 which is thin and spreads laterally. After the inflection point 1 at the stroke position b, the force felt by the operator continuously increases until an inflection point 2.

The inflection point 2 is due to squashing of the cylindrical portion 22 of the libber dome 20 from the inflection point 2 to the inflection point 3, and the stroke characteristics have a local maximum at the inflection point 2. That is, the stroke force increases as approaching the inflection point 2, has a peak value at the inflection point 2, and decreases after the inflection point 2. The operator then feels a clear detent feeling. This detent feeling is a soft, elastic tactile sensation which is characteristic of rubber. This tactile sensation is suitable for the EPB switch device 1 mounted on the shift lever 80 of the vehicle 100.

Electrical switching of the main body 30 is performed to match the timing of this detent feeling felt by the operator. That is, around the inflection point 2 between the inflection point 2 and the inflection point 3, the operation portion 32 of the main body 30 is pushed by the pushing portion 13 of the knob 10 and the two microswitches of the main body 30 change from the OFF state to the ON state. Then, the terminal connected to the two electrical terminals: P SW1, P SW2 shown in FIG. 3 change from the electrical terminal: P SW3 to the electrical terminal: P SW4.

Strictly speaking, force is also required for an operation to cause the microswitches of the main body 30 to change from the OFF state to the ON state. However, enough force to be felt by the operator is not generated in the small microswitches. For this reason, the rubber dome 20 as a detent member not involved in electrical switching is used separately.

If the rubber dome 20 has a similar shape to the rubbers of the microswitches of the main body 30 with a ratio of similitude of 2:1, an area in a direction perpendicular to the rotational symmetry axis is four times and a thickness of the cylindrical portion 22, etc., is double. Based on this, the stroke force of one rubber dome 20 is needed several times larger than that of the two microswitches. Even if the similar shapes are not the same, enough force to be felt by the operator can be produced by adding the rubber dome 20.

FIG. 5C is a diagram illustrating the state at the stroke position c which is near the inflection point 3 in FIG. 4. The cylindrical portion 22 of the rubber dome 20 is squashed. The operation portion 32 of the main body 30 is slightly protruding. Each of the two microswitches of the main body 30 is in the ON state.

When the operator further pushes the operation portion 12 of the knob 10 from the state shown in FIG. 5C, the squashed rubber dome 20 is further pushed. Therefore, after the inflection point 3, the force felt by the operator increases again as shown in FIG. 4. In addition, the force required for deformation is more than for elastic deformation of the cylindrical portion 22 which is not squashed. The stroke substantially stops near this point.

Then, when the operator stops performing the push operation on the operation portion 12 of the knob 10 for the EPB, the knob 10 returns to the state shown in FIG. 5A by an elastic force of the rubber dome 20 and a biasing force of the operation portion 32 of the main body 30. Each of the two microswitches of the main body 30 turns to the OFF state.

### Effects of the First Embodiment of the Invention

In the embodiment of the invention described above, the knob and the switch main body, and additionally, the detent member not involved in electrical switching, are serially arranged. It is thereby possible to obtain a sufficient detent feeling even though the size is small.

### Second Embodiment

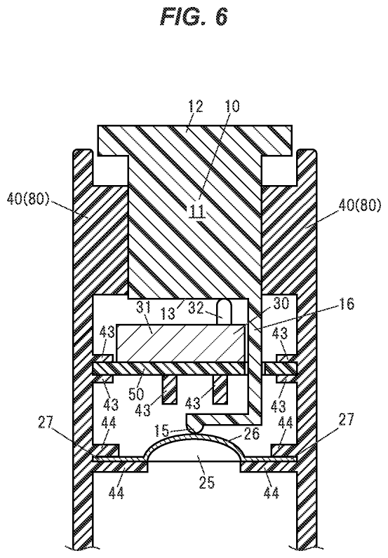

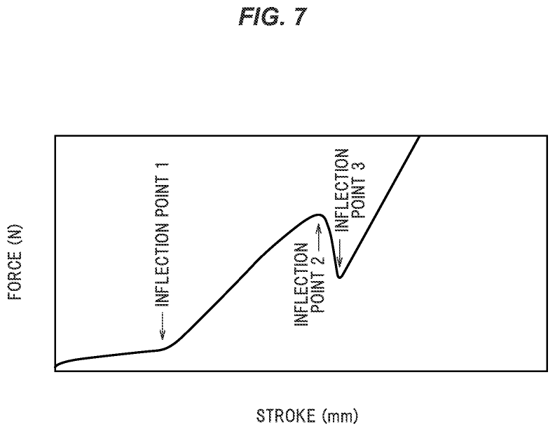

FIG. 6 is a schematic structural cross-sectional view showing the switch device in the second embodiment of the invention and is a cross-sectional view taken along line A-A in FIG. 1. FIG. 7 is a diagram illustrating stroke characteristics of the switch device in the second embodiment of the invention. In the following description, portions having the same configurations and functions as those in first embodiment are denoted by the same reference numerals.

This switch device 1 is different from the switch device 1 described in the first embodiment in the detent member and the arrangement position of the detent member, etc.

A metal dome 25 is used as the detent member, instead of the rubber dome 20. In addition, the knob 10, the main body 30 and the detent member are serially arranged in this order, instead of the arrangement in which the detent member is located between the knob 10 and the main body 30. In addition, the detent member is attached to the support 40 and sandwiched between the knob 10 and the support 40, instead of the arrangement in which the detent member is attached to the knob 10 and sandwiched between the knob 10 and the support 40. The knob 10 and the support 40, etc., have shapes corresponding to these arrangements. Next, these differences will be mainly described.

The metal dome 25 is formed of a metal and has a rotationally symmetric shape, as shown in FIG. 6. The metal dome 25 has a dome portion 26 having a dome shape and serving as a deformable portion, and a fixed portion 27. The fixed portion 27 of the metal dome 25 is attached to a supporting portion 44 of the support 40.

The knob 10 has the pillar portion 11, the operation portion 12, the pushing portion 13, the pushing portion 15, and an extension portion 16. The pushing portion 13 is the other end (the lower end in FIG. 6) of the pillar portion 11. The pushing portion 13 is a portion with which the knob 10 pushes the main body 30 when the operator pushes the operation portion 12. The pushing portion 15 is formed at a tip of the extension portion 16 that extends from the other end (the lower end in FIG. 6) of the pillar portion 11 in a direction along the shift lever 80. The pushing portion 15 is a portion with which the knob 10 pushes the metal dome 25 when the operator pushes the operation portion 12. The extension portion 16 extends to an opposite side to the pillar portion 11 and the operation portion 12 of the knob 10 relative to the main body 30 and reaches near the metal dome 25.

FIG. 7 is a diagram illustrating stroke characteristics of the switch device 1 due to the metal dome 25. FIG. 7 shows the inflection point 1, the inflection point 2 and the inflection point 3, similarly to the diagram of stroke characteristics of the switch device 1 due to the rubber dome 20 shown in FIG. 4. Here, a slope between the inflection point 2 and the inflection point 3 is steeper in the stroke characteristics due to the metal dome 25 than those due to the rubber dome 20. Therefore, the detent feeling felt by the operator between the inflection point 2 and the inflection point 3 is a hard, metallic, sharp tactile sensation such as “click” or “clack”.

As described above, the functions and effects described for the first embodiment can be also obtained in the second embodiment.

Although the embodiments of the invention have been described, these embodiments are merely examples and the invention according to claims is not to be limited thereto. These new embodiments and modifications thereof may be implemented in various other forms, and various omissions, substitutions and changes, etc., can be made without departing from the gist of the invention.

Although the configuration using the rubber dome or the metal dome as the detent member has been described in the embodiments, it is not limited thereto. For example, the detent member is not limited to a single member and may be a mechanism using a spring and a jig.

In addition, although the configuration in which the detent member is not involved in electrical switching of the switches of the main body and is arranged between the knob and the support has been described, it is not limited thereto. The configuration may be such that, e.g., the detent member is arranged between the knob and the operation portion of the main body.

In addition, the configuration of using one detent member has been described, it may be configured to use plural detent members. In this case, alignment thereof may be linear or may be parallel. In this regard, however, arrangement of the plural detent members is desirably linear in the moving direction of the knob.

In addition, although the configuration in which two microswitches are provided and form a normally-closed circuit by connection between the respective ON terminals and between the respective OFF terminals has been described as the configuration with the fail-safe function, it is not limited thereto. For example, the two microswitches may form a normally-closed circuit without connection between the respective terminals. In addition, the configuration with the fail-sate function is not limited to the normally-closed circuit.

In addition, although the configuration in which the main body has two microswitches has been described, it is not limited thereto. For example, the main body may have a single switch and the detent feeling of the switch device may be increased by the detent member. Alternatively, the main body may include not less than two switches.

In addition, although the configuration in which the shift lever itself serves as the support has been described, the switch device may be mounted on the shift lever by using a separately-provided support.

In addition, it has been described as being mounted on the shift lever of the vehicle and the device to be controlled has been described as the EPB, it is not limited thereto. For example, it may be provided as a switch device for mode switching, etc., and mounted at a tip portion of another lever. In addition, it is not limited to the levers, and it is particularly effective when mounted in a location where a mounting area is limited but the depth is enough.

Note that, not all combinations of the features described in these embodiments are necessary to solve the problem of the invention. Further, these embodiments and modifications thereof are included within the scope and gist of the invention and also within the invention described in the claims and the range of equivalency.

### REFERENCE SIGNS LIST

1 SWITCH DEVICE
10 KNOB
11 PILLAR PORTION
12 OPERATION PORTION
13 PUSHING PORTION
14 HOUSING PORTION
14a INSTALLATION PORTION
15 PUSHING PORTION
16 EXTENSION PORTION
20 RUBBER DOME
21 BASE PORTION
22 CYLINDRICAL PORTION
23 SKIRT PORTION
24 FIXED PORTION
25 METAL DOME
26 DOME PORTION
27 FIXED PORTION
30 MAIN BODY
31 CASE
32 OPERATION PORTION
40 SUPPORT
41 SUPPORTING PORTION
42 SUPPORTING PORTION (WALL)
43 SUPPORTING PORTION
44 SUPPORTING PORTION
50 CIRCUIT BOARD
60 STEERING WHEEL
70 WIPER SYSTEM LEVER
80 SHIFT LEVER
90 STEERING COLUMN
100 VEHICLE

1. A switch device, comprising:
a knob;
a support to support the knob to be movable in a linear direction;
a switch main body to make electrical switching upon an operation of the knob; and
a detent member to give a detent feeling to the operation on the knob,
wherein the knob, the switch main body and the detent member are serially arranged in the linear direction.

2. The switch device according to claim 1, further comprising a wall to restrict movement of the detent member, the detent member being movable together with the knob.

3. The switch device according to claim 2, wherein the detent member is attached to the knob.

4. The switch device according to claim 2, wherein the wall is provided on the support.

5. The switch device according to claim 2, wherein an operation portion of the switch main body is arranged on the switch main body side relative to the wall in the linear direction.

6. The switch device according to claim 1, wherein the detent member is in a shape having a large diameter side and a small diameter side, and wherein the small diameter side is arranged on the switch main body side between the knob and the switch main body.

7. The switch device according to claim 1, wherein the detent member comprises a rubber dome comprising a fixed portion and a deformable portion.

8. The switch device according to claim 1, wherein the support is mounted on a rod-shaped lever.

9. The switch device according to claim 2, wherein the detent member and the wall are arranged within a width of the knob.

10. The switch device according to claim 1, wherein a stroke force of the detent member is larger than a force to allow the electrical switching of the switch main body.
